(19) United States
(12) Patent Application Publication
(10) Pub. No.: US 2026/0249565 A1
(43) Pub. Date: Aug. 27, 2026

(54) METHOD OF MAKING CARBON FIBRE REINFORCED SILICONE COMPOSITE MATERIAL AND SHAPED ARTICLE OBTAINED THEREBY

(71) Applicant: CFP Composites LTD., Dudley, West Midlands (GB)

(72) Inventors: Simon Price, Dudley, West Midlands (GB); Darren Deakin, Dudley, West Midlands (GB)

(21) Appl. No.: 19/162,850

(22) PCT Filed: Mar. 6, 2024
(86) PCT No.: PCT/GB2024/050595

§ 371 Date: Sep. 5, 2025

(30) Foreign Application Priority Data
Mar. 6, 2023 (GB) 2303253.5

(51) Int. Cl. B29C 70/12; B29C 70/34; B29K 83/00; B29K 105/12; B29K 307/04; B29L 31/30

(52) U.S. Cl. CPC B29C 70/12; B29C 70/34; B29K 2083/00; B29K 2105/12; B29K 2307/04; B29K 2313/00; B29K 2995/0088; B29K 2995/0094; B29L 2031/30

(57) ABSTRACT

A method of making a fibre-based composite material, comprising: a) providing a starting material which comprises liquid carrier, fibres and binder, wherein the binder comprises silicone resin and wherein the fibres are chopped carbon fibres which comprise a mixture of three or more different lengths of fibre each within the range of from 6 mm to 48 mm, wherein a first length is within the range of from 6 mm to 18 mm, a second length is within the range of from 19 mm to 36 mm and a third length is within the range of from 37 mm to 48 mm; b) dropping the starting material from a height onto a substrate, via a plurality of outlet points, so as to deposit fibres and binder onto the substrate in the form of a three-dimensional fibre matrix; and c-i) curing the binder by the application of heat whilst applying a pressure of from 100 kPa to 50,000 kPa.

The present invention relates to a fibre-based composite material that can withstand high temperatures, such as 1000° C. or higher, or 1200° C. or higher. The material can withstand the high temperatures encountered in a fire and is also flame resistant. Therefore, the composite material may suitably be used to provide fire protection.

### BACKGROUND TO THE INVENTION

Composite materials are known in the art and are used in a range of applications. These materials comprise fibres, for example glass fibre or carbon fibres, and a binder or resin, such as a phenolic or epoxy resin. The use of carbon fibres in such composite materials is known to provide improved properties—including lower weight, improved damage resistance and corrosion resistance, and negligible thermal expansion.

Due to composite materials combining low weight with high mechanical stability, they are in particular suitable for transport applications (e.g., automotive, railway, marine, aerospace).

However, many countries have strict requirements with respect to heat resistance and fire protection, in particular in applications for the transportation of passengers.

It would therefore be desirable to improve the heat resistance and fire protection characteristics of components that are currently made of composite material.

Improved heat resistance and fire protection characteristics would also allow composite material to be used in the manufacture of a wider range of products. For example, there are many components in the aerospace industry, e.g., components in aviation engines, that are not currently made of composite material because they are required to maintain structural integrity in the event of fire.

In general, products such as fire doors, walls, floor panels, ceiling panels, decks, platforms and cladding could be made from composite material if the material was able to provide heat and fire resistance. These products could be used in, for example, vehicles for the mass transportation of passengers (mass transit), or in freight shipping.

When considering electric vehicles, composite materials can be used to provide housings or enclosures for batteries, thereby providing a secure yet lightweight battery pack.

Improved heat resistance and fire protection characteristics would therefore allow composite material to be used in battery packs for electric vehicles, especially in mass transit, e.g. lithium ion battery packs.

In general, there continues to be an increased desire to improve safety and there is an ongoing need to comply with fire regulations and legislation.

WO2011/007184 discloses a method of forming a three-dimensional fibre structure. This allows the formation of a stochastic fibre preform comprising a non-woven substrate of fibres having a three-dimensional matrix, wherein the fibres are held together in the matrix formation by a cured binder. The fibres may, in particular, be carbon fibres. However, the achievement of high temperature resistance, such as 1000° C. or higher, is not taught, nor is fire protection taught.

### SUMMARY OF THE INVENTION

The invention provides, in a first aspect, a method of making a fibre-based composite material, the method comprising:
a) providing a starting material which comprises liquid carrier, fibres and binder, wherein the binder comprises silicone resin and wherein the fibres are chopped carbon fibres which comprise a mixture of three or more different lengths of fibre each within the range of from 6 mm to 48 mm;
b) dropping the starting material from a height onto a substrate, via a plurality of outlet points, so as to deposit fibres and binder onto the substrate in the form of a three-dimensional fibre matrix; and c-i) curing the binder, by the application of heat whilst applying a pressure of from 100 kPa to 50,000 kPa, to thereby obtain fibre-based composite material.

The method uses an approach based on that described in WO2011/007184 to form a three-dimensional fibre matrix. However, surprisingly, by using a mixture of chopped fibres of three or more different lengths within the range from 6 mm to 48 mm and by using a silicone-based resin, it has been shown that good heat resistance and fire protection performance is achieved.

In particular, the fibre-based composite material made by the method of the present invention may have the ability to withstand a temperature of 1000° C. or more for 30 minutes or more, such as an hour or more. In one embodiment, the fibre-based composite material made by the method of the present invention may have the ability to withstand fire for 30 minutes or more, such as an hour or more. This may involve withstanding a temperature of 1000° C. or more and withstanding the presence of a flame for 30 minutes or more, such as for an hour or more.

Fire resistance may be established by use of a blow torch (e.g. a propylene and propane gas fueled blow torch) to apply a flame to the surface of a 2 mm thick panel of the material for an hour and to visually assess damage and any burn-through. A thermocouple and a temperature data logger can be used to monitor the temperature at the surface.

Advantageously, the 2 mm thick panel of fibre-based composite material according to the invention can withstand a flame for 30 minutes or more, or an hour or more (such as two hours or more, or even five hours or more), even with the surface temperature reaching 1000° C. or higher (such as 1100° C. or higher, or 1200° C. or higher), without there being burn-through.

In contrast, the inventors have determined that if the carbon fibre is provided in chopped form with a single fibre length, or with lengths outside the 6 mm-48 mm range, or if a different binder system is used, the resulting products have poorer heat and fire resistance.

The 2 mm thick panel of this comparative material cannot withstand high temperature and a flame, with the surface temperature reaching 1000° C.-1200° C. After an hour there was extensive visible damage and/or the panel was burnt through.

In a preferred embodiment of the disclosure, reflected in the claimed invention, there are three or more different lengths of fibre, wherein a first length is within the range of from 6 mm to 18 mm, wherein a second length is within the range of from 19 mm to 36 mm and wherein a third length is within the range of from 37 mm to 48 mm. Very good heat and fire protection is achieved with the use of such a fibre blend.

Particularly good heat and fire protection is achieved when the mixture of fibres comprises from 10 to 50 wt % fibres within the length range of from 6 mm to 18 mm, from 30 to 70 wt % fibres within the length range of from 19 mm to 36 mm, and from 5 to 35 wt % fibres within the length range of from 37 mm to 48 mm.

According to a second aspect of the invention, therefore, there is provided a fibre-based composite material comprising a non-woven substrate of fibres in the form of a three-dimensional matrix, wherein the fibres are held together in the matrix formation by a cured binder, wherein the binder comprises silicone resin and wherein the fibres are chopped carbon fibres which comprise a mixture of three or more different lengths of fibre each within the range of from 6 mm to 48 mm.

In a preferred embodiment, reflected in the claimed invention, there are three or more different lengths of fibre, wherein a first length is within the range of from 6 mm to 18 mm, wherein a second length is within the range of from 19 mm to 36 mm and wherein a third length is within the range of from 37 mm to 48 mm. Very good heat and fire protection is achieved with the use of such a fibre blend.

Particularly good heat and fire protection is achieved when the mixture of fibres comprises from 10 to 50 wt % fibres within the length range of from 6 mm to 18 mm, from 30 to 70 wt % fibres within the length range of from 19 mm to 36 mm, and from 5 to 35 wt % fibres within the length range of from 37 mm to 48 mm.

The material of the second aspect may be obtained by the method of the first aspect. In one embodiment, the material is obtainable by the method of the first aspect or was obtained by the method of the first aspect.

The material of the second aspect may, therefore, be a stochastic three-dimensional fibre matrix, wherein the matrix has fibres arranged in the x, y and z directions, and these fibres are randomly oriented.

As the skilled person will appreciate, the material of the second aspect could be analysed by scanning electron microscopy (SEM). An SEM image of the material will clearly show the different length fibres intertwined and randomly arranged within the material.

The method of the first aspect may be used to obtain a shaped article. The article may be a panel or may be a three-dimensional moulded component. The article may be a heat resistant article (e.g. resistant to temperatures of 1000° C. or more for 30 minutes or more) and/or may be a fire-resistant article (e.g. resistant to both flames and temperatures of 1000° C. or more for 30 minutes or more).

It may be that step c) of the method of the first aspect involves applying heat and pressure such that the fibre-based composite material is shaped and cured into the form of a panel.

In other words, a flat sheet-like structure is obtained.

Alternatively, in step c) the fibre-based composite material may be provided in a mould and therefore the heat and pressure that are applied result in the fibre-based composite material being shaped and cured into the form of a three-dimensional moulded component. In particular, the substrate may be provided within a mould, and therefore the three-dimensional fibre matrix will be deposited on the substrate within this mould and can then be heated and pressed within this mould to consequently be shaped and cured into the form of a three-dimensional moulded component.

According to a third aspect of the invention, therefore, there is provided a shaped article comprising fibre-based composite material according to the second aspect. The article may be a panel or may be a three-dimensional moulded component.

The article may be for use in transportation, for example in mass transit of people, such as a component part of a train (underground or overground), tram, bus, ferry, coach, cruise ship or aeroplane.

The article may, in one embodiment, be for use in the marine industry, e.g. freight shipping, or in the automotive industry, or in the aerospace industry.

The article may be for use in an electric vehicle. The article may form part of a battery pack for an electric vehicle, especially in mass transit, e.g. it may form part of a lithium ion battery pack. In one embodiment the article is a housing or enclosure for a battery.

The article may, in one embodiment, be selected from: doors, walls, floor panels, ceiling panels, decks, platforms and cladding. The article may be a 3D moulded component or panel for use in a vehicle, such as a train, aeroplane, ferry, ship, coach, bus, tram or car. The article may be an aerospace part or an automotive part or a shipping part.

The invention provides, in a fourth aspect, the use of the fibre-based composite material according to the second aspect in the manufacture of an article that has the ability to withstand heat and/or fire for a period of time, such as 30 minutes or more, or an hour or more, or two hours or more, such as five hours or more.

It may be that the article that has the ability to withstand a temperature of 1000° C. or higher for a period of time, such as 30 minutes or more, or an hour or more, or two hours or more, such as five hours or more.

In one embodiment, the article remains intact in the presence of a flame for a period of time, such as 30 minutes or more, or an hour or more, or two hours or more, such as five hours or more.

In one embodiment, the article remains intact at a temperature of 1000° C. or higher for a period of time, such as 30 minutes or more, or an hour or more, or two hours or more, such as five hours or more.

The present invention also provides for the production of precursors to the shaped articles of the invention. These precursors may be cured into the desired shaped article when required.

The invention therefore provides, in a fifth aspect, a method of making a fibre-based composite precursor, the method comprising:
a) providing a starting material which comprises liquid carrier, fibres and binder, wherein the binder comprises silicone resin and wherein the fibres are chopped carbon fibres which comprise a mixture of three or more different lengths of fibre each within the range of from 6 mm to 48 mm;
b) dropping the starting material from a height onto a substrate, via a plurality of outlet points, so as to deposit fibres and binder onto the substrate in the form of a three-dimensional fibre matrix; and
c-ii) heating the three-dimensional fibre matrix to a temperature that is 40° C. or more, without curing the binder, to thereby obtain a fibre-based composite precursor.

In a preferred embodiment, reflected in the claimed invention, there are three or more different lengths of fibre, wherein a first length is within the range of from 6 mm to 18 mm, wherein a second length is within the range of from 19 mm to 36 mm and wherein a third length is within the range of from 37 mm to 48 mm. Very good heat and fire protection is achieved with the use of such a fibre blend.

Particularly good heat and fire protection is achieved when the mixture of fibres comprises from 10 to 50 wt % fibres within the length range of from 6 mm to 18 mm, from 30 to 70 wt % fibres within the length range of from 19 mm to 36 mm, and from 5 to 35 wt % fibres within the length range of from 37 mm to 48 mm.

In step c-ii) the temperature of heating and the duration of the heating are chosen such that the binder does not cure. The skilled person will appreciate that this may involve a lower temperature for a longer period of time, or a higher temperature for a shorter period of time. For example, the heating temperature may be from 40° C. to 100° C., such as from 40° C. to 80° C. or from 40° C. to 60° C., for a period of time of from 3 to 15 minutes, such as from 5 to 15 minutes. Alternatively, the heating temperature may be from 100° C. to 250° C., such as from 125° C. to 225° C. or from 150° C. to 200° C., for a period of time of 1 minute or less, such as from 15 seconds to 45 seconds. In general, it may be desirable that the heating temperature does not exceed 225° C., e.g. does not exceed 200° C., and it may be desirable that the heating time does not exceed 15 minutes, e.g. does not exceed 10 minutes.

In step c-ii) the binder is heated such that it softens or melts around the fibres, but does not cure. It will be appreciated that heating the matrix may also lead to the evaporation of liquid carrier and therefore the matrix will be dried by this step.

It may be that between step b) and step c-ii) a dewatering step is carried out, such that liquid carrier is removed from the matrix. This step may involve allowing liquid carrier to be drawn out of the matrix under gravity and/or may involve the use of a vacuum force to draw liquid carrier out of the matrix.

According to a sixth aspect of the invention, therefore, there is provided a fibre-based composite precursor, comprising a non-woven substrate of fibres in the form of a three-dimensional matrix, wherein the fibres are held together in the matrix formation by an uncured binder, wherein the binder comprises silicone resin and wherein the fibres are chopped carbon fibres which comprise a mixture of three or more different lengths of fibre each within the range of from 6 mm to 48 mm.

In a preferred embodiment, reflected in the claimed invention, there are three or more different lengths of fibre, wherein a first length is within the range of from 6 mm to 18 mm, wherein a second length is within the range of from 19 mm to 36 mm and wherein a third length is within the range of from 37 mm to 48 mm. Very good heat and fire protection is achieved with the use of such a fibre blend.

Particularly good heat and fire protection is achieved when the mixture of fibres comprises from 10 to 50 wt % fibres within the length range of from 6 mm to 18 mm, from 30 to 70 wt % fibres within the length range of from 19 mm to 36 mm, and from 5 to 35 wt % fibres within the length range of from 37 mm to 48 mm.

The precursor of the sixth aspect may be obtained by the method of the fifth aspect. In one embodiment, the precursor is obtainable by the method of the fifth aspect or was obtained by the method of the fifth aspect.

According to a seventh aspect of the invention, the precursor of the sixth aspect is used to obtain the material of the second aspect or the article of the third aspect. In particular, the material or article may be obtained by heating the precursor whilst applying a pressure of from 100 kPa to 50,000 kPa, to cure the binder. This curing of the binder may be as described in relation to step c-i) of the first aspect.

According to an eighth aspect, a method of producing a fibre-based composite material, which may be in the form of a shaped article, comprises the steps of:
i) providing a precursor of the sixth aspect; and
ii) curing the binder, by the application of heat whilst applying a pressure of from 100 kPa to 50,000 kPa.

Step i) may be achieved by carrying out the method of the fifth aspect.

The curing of the binder in step ii) may be as described in relation to step c-i) of the first aspect.

It may be that step ii) involves applying heat and pressure such that the fibre-based composite precursor is shaped and cured into the form of a panel. In other words, a flat sheet-like structure is obtained.

Alternatively, in step i) the fibre-based composite precursor may be provided in a mould and therefore in step ii) the heat and pressure that are applied result in the fibre-based composite precursor being shaped and cured into the form of a three-dimensional moulded component.

Thus, by carrying out the method of the eighth aspect, a shaped article comprising fibre-based composite material according to the second aspect may be obtained. The article may be a panel or may be a three-dimensional moulded component.

It will be appreciated that all optional/preferred features disclosed in relation to the method of the first aspect regarding the carbon fibres and the binder will also apply (mutatis mutandis) to the second to eighth aspects. Equally, all optional/preferred features disclosed in relation to the method of the first aspect regarding steps a) and b) will also apply (mutatis mutandis) to the method of the fifth aspect.

### DETAILED DESCRIPTION OF THE INVENTION

### Carbon Fibres:

The present invention uses a mixture of chopped carbon fibres of three or more different lengths within the range from 6 mm to 48 mm (such as from 12 mm to 48 mm). The use of a blend of three or more different lengths of fibre within this length range has been found to enable the production of composite materials having good heat and fire protection performance.

In a preferred embodiment, reflected in the claimed invention, there are three or more different lengths of fibre, wherein a first length is within the range of from 6 mm to 18 mm, wherein a second length is within the range of from 19 mm to 36 mm and wherein a third length is within the range of from 37 mm to 48 mm. Very good heat and fire protection is achieved with the use of such a fibre blend.

Particularly good heat and fire protection is achieved when the mixture comprises from 10 to 50 wt % (such as 15 to 50 wt %) fibres within the range of from 6 mm to 18 mm, from 30 to 70 wt % (such as 35 to 70 wt %) fibres within the range of from 19 mm to 36 mm and from 5 to 35 wt % (such as 10 to 35 wt %) fibres within the range of from 37 mm to 48 mm.

In one preferred embodiment, the mixture comprises from 15 to 45 wt % (such as 20 to 45 wt %) fibres within the range of from 6 mm to 18 mm, from 35 to 65 wt % (such as 40 to 65 wt %) fibres within the range of from 19 mm to 36 mm and from 10 to 30 wt % (such as 15 to 30 wt %) fibres within the range of from 37 mm to 48 mm.

In a particularly preferred embodiment, the mixture comprises from 20 to 40 wt % (such as 25 to 35 wt %) fibres within the range of from 6 mm to 18 mm, from 40 to 60 wt % (such as 45 to 55 wt %) fibres within the range of from 19 mm to 36 mm and from 15 to 25 wt % (such as 18 to 22 wt %) fibres within the range of from 37 mm to 48 mm. Particularly good heat and fire protection is achieved when the mixture comprises such a blend of different length fibres.

For example, there may be 28 wt % fibres within the range of from 6 mm to 18 mm, 52% fibres within the range of from 19 mm to 36 mm, and 20 wt % fibres within the range of from 37 mm to 48 mm.

In one embodiment, the fibres used are a blend of fibres having four or more, or five or more different length fibres.

In one preferred embodiment, the fibres used are a blend of fibres where the lengths are selected from 6 mm, 12 mm, 18 mm, 24 mm, 30 mm, 36 mm, 42 mm and 48 mm, with there being three or more (such as four or more, or five or more) different length fibres.

In one preferred embodiment, the mixture comprises from 20 to 40 wt % (such as 25 to 35 wt %) fibres selected from 6 mm, 12 mm and 18 mm, from 40 to 60 wt % (such as 45 to 55 wt %) fibres selected from 24 mm, 30 mm and 36 mm, and from 15 to 25 wt % (such as 18 to 22 wt %) fibres selected from 42 mm and 48 mm.

In one preferred embodiment, the fibres used are a blend of fibres where the lengths are selected from 12 mm, 18 mm, 24 mm, 30 mm, 36 mm, 42 mm and 48 mm, with there being three or more (such as four or more, or five or more) different length fibres.

In one preferred embodiment, the mixture comprises from 20 to 40 wt % (such as 25 to 35 wt %) fibres selected from 12 mm and 18 mm, from 40 to 60 wt % (such as 45 to 55 wt %) fibres selected from 24 mm, 30 mm and 36 mm, and from 15 to 25 wt % (such as 18 to 22 wt %) fibres selected from 42 mm and 48 mm.

In one preferred embodiment, 95 wt % or more, such as 98 wt % or more, or 99 wt % or more, or 100%, of the fibres have lengths in the range of from 6 mm to 48 mm (such as from 12 mm to 48 mm).

The fibres in the starting material comprise carbon fibre, which may be virgin carbon fibre and/or recycled carbon fibre. Other fibre types may also optionally be present with the carbon fibres. Such additional fibre types in the starting material may, for example, be selected from metal fibres, glass fibres, PPS, PEEK, aramid fibres such as Kevlar, or other fibres suitable for use in ablative and braking applications.

Preferably 60 wt % or more of the fibres are carbon fibre, such as 70 wt % or more, 80 wt % or more, 90 wt % or more, 95 wt % or more, or 99 wt % or more.

In one embodiment, the fibres are carbon fibres having a diameter up to 20 microns, especially from 5 microns up to 20 microns or from 6 microns to 12 microns. In one embodiment the carbon fibres have a diameter of from 5 microns to 10 microns, e.g. about 7 microns.

In one embodiment, the method comprises chopping carbon fibre into lengths, to obtain a blend of fibres having three or more (e.g. four or more, or five or more) different length fibres. However, in an alternative embodiment, the chopped fibre blend has already been prepared and is provided ready for use.

The skilled person will appreciate that the lengths of fibres in a mixture can be measured and the proportions of each different length can be calculated. Cutting machines, e.g. cutting machines provided with a chopping wheel blade, can be used to chop a length of carbon fibre into pieces having three or more different lengths and to therefore prepare a mixture of three or more different lengths of fibre.

### Resin:

The present invention uses a silicone resin. The use of this type of resin has been found to enable the production of composite materials having good fire protection performance.

As the skilled person will be aware, silicone resins are highly crosslinked siloxane (silicon-oxygen) lattice systems. These comprise a silicate (SiO_{4/2}) or silsesquioxane (R—SiO_{3/2}) structures, where R represents an alkyl or aryl group (e.g. methyl or phenyl).

In general, a siloxane has the formula RₙSiXₘO_{y}, where R is an alkyl or aryl organic substituent, such as C1-C6 alkyl or C5-6 aryl, usually methyl or phenyl, X is a functional group such as —H, —OH, —Cl or —ORₐ where Rₐ is C1-4 alkyl, and n+m+y=4. Commonly used siloxane monomeric units are Me₃SiO (M), Me₂SiO₂ (D), MeSiO₃ (T), and SiO₄ (Q).

Resins can be referenced with respect to the units they are built from, for example known silicone resins include DT resins, MQ resins, MDT resins, MTQ resins and QDT resins.

Organo-chloro-siloxanes or organo-alkoxy-siloxanes can be converted to organo-oligosiloxane intermediates by hydrolysis or alcoholysis and partial condensation. These intermediates are then converted to curable silicone resins by condensation of silanol groups. Alternatively, modification with organic resins or organic resin intermediates can be carried out, to obtain silicone combination resins.

Crosslinking components can be introduced with tri- or tetra-functional silanes. Silanes that are commonly used include: tetraethoxysilane, methyl-trichlorosilane, phenyl-trichlorosilane, dimethyl-dichlorosilane, phenylmethyl-dichlorosilane, diphenyl-dichlorosilane, trimethyl-chlorosilane and tetrachlorosilane.

Silicone resins are conventionally characterized by their reactive groups (e.g. silanol, methoxy), by their substituents (e.g. methyl, phenyl) and by their molecular weight.

The inclusion of reactive side group functionality such as silanol, methoxy, vinyl, acrylate, epoxy, mercaptan or amine, can be beneficial when obtaining resins for use in thermosetting polymer matrix composites. In one embodiment, the resin includes silanol functionality.

The molecular weight of the resin, as a weight average molecular weight may, for example, be in the range of 500 to 10,000, such as from 1,000 to 5,000, e.g. from 1,500 to 4,500.

The resin may, for example, be a methyl-substituent based silicone resin, or a phenyl-substituent based silicone resin, or a silicone resin with both methyl and phenyl substituents (e.g. with a phenyl:methyl weight ratio of from 0.1:1 to 5:1, such as from 0.25:1 to 4:1, e.g. from 0.5:1 to 3:1).

Preferably the binder is added such that the percentage of binder in the final product is from 5% to 80% of the final weight of the dried fibre-based composite material. For example, the percentage of binder in the final product may be from 10% to 80% of the final weight of the dried fibre-based composite material, such as from 20% to 80% or from 30% to 80%.

In a preferred embodiment the binder may comprise from 30% to 70%, e.g. from 40% to 60% or from 50% to 60%, of the final weight of the dried fibre-based composite material.

The skilled person will appreciate than in a fibre-based composite material the binder content may be established by weighing the material, subjecting the material to a temperature above which the binder will be burnt out, then reweighing, and calculating a weight difference between the weights.

### Liquid Carrier

The liquid carrier may be an aqueous product, such as water or an aqueous solution, or may be a non-aqueous product, such as an organic solvent. In a preferred embodiment the carrier is an aqueous liquid, such as water. More viscous materials may be used as the liquid carrier if the starting material is heated prior to passing over the substrate.

The liquid carrier acts as a medium to separate the fibres and to move them via fluid flow to the substrate. It is desirable that the liquid carrier has a specific gravity lower than that of the fibres being used in the starting mixture. Use of a liquid carrier that has a specific gravity less than that of the fibre being used allows the liquid carrier to disperse the fibre without the fibre floating and to move the fibre in a flow of the liquid carrier. Carbon fibre has a specific gravity of 1.7 to 1.8 and so a liquid carrier having a specific gravity of less than 1.7 should preferably be used.

The liquid carrier (e.g. water) may include one or more further constituents, which may, for example, be selected from additives known for use in wet laid non-woven products, such as dispersion aids, viscosity modifiers, thixotropes and surfactants.

### Step a): Providing a Starting Material:

In step a) a starting material is provided. The starting material comprising the liquid carrier, fibres and binder may desirably form a slurry.

The starting material may be obtained by combining the liquid carrier, fibres and binder in any order. For example, fibres may be added to a liquid carrier, followed by the addition of binder. Alternatively, binder may be added to a liquid carrier, followed by the addition of fibres.

Preferably the starting material is in the form of a slurry or a dispersion of the fibres in the liquid carrier.

The starting material may have a fibre to liquid weight ratio of from 1:25 to 1:200, such as from 1:50 to 1:175, preferably from 1:75 to 1:150, such as from 1:85 to 1:125. In one embodiment, the starting material has a fibre to liquid weight ratio of from 1:90 to 1:125.

In one embodiment, the starting material includes 95 wt % or more liquid carrier, such as 98 wt % or more or 99 wt % or more. It may be that the starting material includes from 95 to 99.9 wt % liquid carrier, e.g. from 98 to 99.8 wt % liquid carrier.

The starting material may be provided in a holding container. The starting material in the holding container may be heated. Heating of the starting mixture facilitates the use of higher temperature binders. Use of a higher temperature also allows the use of more viscous materials for the liquid carrier.

Preferably the starting material is a high shear mixture in which the fibres can be separated and flow freely. It is desirable to maintain a flow of fibres in the starting material and to prevent fibres settling at a bottom of the holding container. Agitation of the mixture may be used. The agitation may be continuous or may be intermittent. A shear mixer may be used.

Preferably the starting material has a low viscosity. Preferably the starting material has a viscosity that is less than 100 mPa s and more preferably less than 50 mPa s and yet more preferably less than 10 mPa s. Most preferably the starting material has a viscosity that is less than 5 mPa s and more preferably less than 3 mPa s and yet more preferably less than 2 mPa s. Preferably the viscosity of the starting material is from 0.1 mPa s to 1 mPa s, such as from 0.5 mPa s to 1 mPa s.

More preferably the liquid carrier has a low viscosity similar to that of water. It may be that the proportion of fibre added to the liquid carrier, relative to the volume of the liquid carrier, is controlled such that the starting material behaves as a non-viscous solution and has a viscosity similar to that of water.

In one embodiment, therefore, the ratio of fibre to liquid carrier is controlled such that the overall viscosity of the starting material is similar to that of water, i.e. approximately 0.8 to 0.9 mPa s.

It may be desirable to include other agents in the starting material or to add such agents to the starting material before carrying out step b). The or each agent may be selected from a group comprising a dispersion agent, a surfactant, a thixotrope or a viscosity modifier, an additive that destabilises the binder in solution, a flocculation agent, an anti-foam agent. Acids, bases and amines may be used as destabilising agents.

In one embodiment an additive filler material in the form of particulates may be included in the starting material or added to the starting material before step b) is carried out. Such an additive filler material may improve a functional performance or the final properties of the composite.

Additive filler materials may be added in an amount, as a percentage by weight of the dried fibrous matrix, of from 1% to 50%, e.g. from 5 to 45%, such as from 10 to 40%. The additive filler material may be supplied as a dry material or in a wet format in the form of a dispersion or solution. Suitable additive filler materials include metals, silicon dioxides and carbon.

Step b): Dropping the Material onto a Substrate:

In step b), the starting material is dropped from a height onto a substrate, via a plurality of outlet points, so as to deposit fibres and binder onto the substrate in the form of a three-dimensional fibre matrix.

Accordingly, the flow of starting material is chaotic, and a number of flows and counter currents direct the fibres in any number of orientations. This results in the formation of a stochastic structure. In a stochastic structure the orientation of the fibres is three-dimensional and fibres are arranged in x, y and z directions. Indeed, fibres may in fact be oriented in most, if not almost all, angles between the plane and 90 degrees thereto. For example, fibres may be oriented in 50% or more (such as 60% or more, 70% or more, 80% or more, 90% or more, or 95% or more) of the angles between the plane and 90 degrees thereto.

Thus, the matrix formed in step b) is a stochastic three-dimensional fibre matrix, wherein the matrix has fibres arranged in the x, y and z directions, and these fibres are randomly oriented.

Individual fibres may be orientated from 0 to ±90° in the perpendicular from the horizontal. Individual fibres may also be randomly orientated within 360° rotation on the horizontal plane.

Preferably, in the three-dimensional matrix 5 wt % or more, such as 10 wt % or more, of the fibres are orientated substantially in a “z” direction. Preferably from 5 to 30 wt %, such as from 10 to 25 wt %, of the fibres are orientated substantially in a “z” direction. More preferably from 10 wt % to 20 wt % of the fibres are orientated substantially in the “z” direction.

As noted above, this three-dimensional matrix is formed by creating a chaotic flow of starting material over the substrate. This chaotic flow is created by dropping the starting material from a height onto the substrate (so that it travels a distance onto the substrate) and passing the starting material onto the substrate via a plurality of outlet points.

Chaotic flow may be understood to be a flow in which the system behaviour is so dependent on the system's precise initial conditions that it is, in effect, unpredictable and cannot be distinguished from a random process. Typically, in flow systems the flow of a chaotic system has a Reynolds number that is indicative of turbulent flow rather than laminar flow.

The Reynolds number (R) of a system is defined by R=(density of system)×(velocity of system)×(distance dropped by system or diameter of pipe through which system flows)/(viscosity of system). The density of the system is measured in kg/m³ and the velocity in m/s. The distance or diameter is measured in m and the viscosity is measured in kg/m s.

The density is measured at room temperature and pressure. Viscosity is measured by a viscosity meter at room temperature and pressure, in particular by a Norcross M8BO viscosity meter (Norcross Corporation, Newton, MA, USA). The velocity of the system (flow rate) is measured using a flowmeter at room temperature and pressure, in particular by a Titan FT2 Turbine flowmeter (Titan Flowmeters, UK).

A laminar flow system would have a value well below 2000, whereas a chaotic or turbulent flow system would have a Reynolds number of above 2000 and may be as high as 3000 or higher, or 4000 or higher.

In one embodiment, the flow of the starting material has a Reynolds number of 2000 or more. It may be that the flow of the starting material has a Reynolds number of 2500 or more; preferably 3000 or more, such as 3500 or more; more preferably 4000 or more, e.g. 4500 or more, 5000 or more, 6000 or more, 7000 or more, 8000 or more, 9000 or more or 10,000 or more. Very high Reynolds numbers may be achieved in some systems and may even be as high as 140,000 to 160,000 or more.

One preferred range is from 3,000 to 10,000 or higher, e.g. from 3,000 to 200,000, such as from 4,000 to 160,000. In some embodiments a preferred range is from 5,000 to 25,500 or higher, e.g. from 5,000 to 180,000. In other embodiments a preferred range may be from 25,500 to 100,000 or higher, e.g. from 25,500 to 170,000.

This chaotic flow is created at least by dropping the starting material from a height onto the substrate (so that it travels a distance onto the substrate) via a plurality of outlet points.

The plurality of outlet points may be provided by a manifold having two or more outlets (e.g. outlet pipes).

Thus, in a preferred embodiment, the starting material may enter a manifold that is provided with multiple outlets before dropping onto the substrate. The manifold may, for example, have from two to twenty outlets, e.g. from two to ten outlets. In one embodiment the manifold has two, four, six, eight or ten outlets, depending on a size of the substrate to be covered. More outlets may be provided if the size of the substrate is increased.

The use of a plurality of outlet points means that the starting material flows over the substrate in multiple flows. There are, therefore, two or more flows of starting material over the substrate. In some embodiments there may be four or six or eight flows. The preferred number of flows may depend on an area of the substrate and matrix to be formed.

The number of flows preferably increases with the area of the matrix to be formed. In one embodiment, an outlet may be provided for each square foot (0.09290 m²) of the substrate.

Each outlet has a diameter and preferably each outlet has substantially the same diameter.

In one embodiment the starting material passes from a holding container into a manifold and collects in the manifold. The starting material passes from the manifold through multiple manifold outlets (e.g. outlet pipes) and drops onto the substrate. The manifold outlets may be substantially at 900 to a surface of the substrate or may be at an acute or obtuse angle thereto. Starting material may flow from the manifold outlets under pressure or may drain from the manifold under gravity.

In some embodiments the starting material is transferred to the manifold by gravity whilst in other embodiments transfer of the starting material may be by means of a pump. A peristaltic pump system is preferred, to prevent fibre damage, but alternative pump systems may be used.

The drop from a height onto the substrate (so that it travels a distance onto the substrate) may involve a drop height of from 0.5 m to 10 m, such as from 0.5 m to 7.5 m; preferably from 0.75 m to 6 m and more preferably from 1 m to 5 m, such as from 1 m to 4 m. In one preferred embodiment the drop height is from 1 m to 3 m, e.g from 1.5 m to 3 m, and it may in particular be from 2 m to 3 m, such as from 2 m to 2.5 m.

A suitable drop height is dependent on the volume of liquid carrier that is required to transfer the fibre. A rate of transfer may also influence the drop height.

In one preferred method the starting material is allowed to fall a distance from a holding container to the substrate via a plurality of outlet points.

The starting material is dropped on to the substrate in step b) such that a fibrous mat is formed on the substrate. Fibres in the mat can therefore link in two dimensions parallel to a plane of the substrate as the fibres are deposited on the substrate as well as in a third dimension perpendicular to the substrate.

It may be desirable that flow of the liquid carrier from the starting material through the substrate is relatively quick. In one embodiment, the velocity of the liquid carrier is 1 m/s or more, such as 2 m/s or more, 3 m/s or more, 4 m/s or more or 5 m/s or more. In another embodiment, the velocity of the liquid carrier is 1 Gm/s or more. Preferably, the flow of the liquid carrier is at a velocity as achieved by a drop of 1 metre or more under gravity.

Optionally, the starting material is provided to the substrate at a pressure, to further create chaotic flow.

Accordingly, in one embodiment, the starting material may be pressurised before passing over the substrate.

In this regard, it may be desirable that there is a suitable pressure in the starting material to achieve a high velocity as the liquid carrier flows from the starting material through the substrate. Preferably this is a pressure of 5 kPa or greater, such as 6 kPa or greater, 7 kPa or greater, 8 kPa or greater, preferably 9 kPa or greater, e.g. 10 kPa or greater. In one embodiment, the minimum pressure of the starting material may be 15 kPa or more, e.g. 20 kPa or more, such as 30 kPa or more.

In one embodiment the starting material is pressurised to a pressure greater than that a pressure created by falling the distance to the substrate, in order to maximise chaotic flow over the substrate. An approximate value of a pressure generated by a drop is 103 kPa (15 psi) per 9.75 m (32 feet). A pressure of 1.5 or 2 times the pressure generated by the drop may be desirable.

For a drop of 2 m a pressure of the starting material may be from 31 kPa (4.5 psi) or more, preferably from 41 kPa (6 psi) or more. For a drop of 4 m a minimum pressure of the starting material may be from 69 kPa (10 psi) or more, preferably from 90 kPa (13 psi). Higher pressures may be preferable.

Optionally, in addition to creating a chaotic flow of starting material over the substrate, a vacuum force is applied to the fibres on the substrate. This may further assist in the formation of the three-dimensional matrix.

In one embodiment, the application of vacuum force to the fibres on the substrate comprises providing multiple vacuum draw points downstream of the substrate.

In one embodiment a vacuum force is applied to the substrate such that liquid carrier is drained through the deposited fibres and is drained from the fibres.

A vacuum force may be applied to the fibres on the substrate. Water molecules, or other liquid molecules, in the deposited fibres are thus subjected to the vacuum force and move through the fibres under the vacuum force. As the water, or other liquid, molecules move through the fibres under the vacuum force the molecules orientate at least some of the fibres in a plane (“z” plane) angled to the plane of the substrate.

Movement of the carrier molecules through the deposited fibres under the vacuum force applied to the substrate further orientates at least some of the fibres in the z plane and assists in forming a stochastic structure.

For example, the fibres may drop onto a first surface of the substrate and a vacuum force may be applied to a second (opposing) surface of the substrate. The vacuum force acts to draw the fibres towards the first surface of the substrate and to form a three-dimensional matrix of fibres. The vacuum force may be applied directly to the second surface of the substrate or may be applied remotely, e.g. when the substrate has a drain unit provided, the vacuum force may be applied to the end of the drain unit furthest removed from the second surface.

In one preferred embodiment the vacuum force may be such that it achieves a low to medium degree of vacuum. The vacuum force may, for example, be 100 kPa (about 750 torr) or lower, such as from 100 kPa down to 3 kPa (about 750 torr to about 25 torr) or from 3 kPa down to 100 mPa (about 25 torr to about 1×10⁻³ torr). Alternatively, a high degree of vacuum may be achieved, by applying a vacuum force of 100 mPa or lower, such as from 100 mPa down to 100 nPa (about 1×10⁻³ torr to about 1×10⁻⁹ torr).

The vacuum force applied may affect the number of fibres orientated in the “z” plane. The vacuum force applied may also affect a distance that the fibres are moved in the “z” plane.

The vacuum force may be applied at an angle of from 45 degrees or more to the plane of the substrate, such as 60 degrees or more, preferably 70 degrees or more, or 80 degrees or more, such as 85 degrees or more. In a more preferred embodiment, the vacuum force is applied at substantially 90 degrees to the plane of the substrate.

The substrate may be provided with a connection to a drain unit, such as a drainage pipe.

A vacuum force may be applied by means of a suction pump, in particular a low vacuum suction pump, attached to the drain unit. The vacuum force may be applied by means of a multipoint vacuum manifold.

### Optional Removal of Liquid Carrier:

In one embodiment, the fibres are deposited onto the substrate and initially some of the liquid carrier is allowed to drain from the fibres under gravity. This may result in a proportion of the liquid carrier, for example 40 wt % or more, 50 wt % or more, 60 wt % or more, 70 wt % or more, or 80 wt % or more, draining from the fibres.

Once a proportion of the liquid carrier has drained (for example 40 wt % or more, 50 wt % or more, 60 wt % or more, 70 wt % or more, or 80 wt % or more) a vacuum force may optionally then be applied to the fibres. This may act to remove a further proportion of the liquid carrier.

Preferably not all the moisture in the fibres is removed under the vacuum force, such that the fibrous matrix contains moisture.

In one embodiment, once liquid has drained from the fibres on the substrate, and any optional vacuum force has been applied, the fibre to liquid ratio may be reduced to the range of from 1:1 to 1:25 or from 1:2 to 1:20, such as from 1:2 to 1:14 or from 1:2 to 1:10, for example from 1:3 to 1:9. In one embodiment, the fibre to liquid ratio is from 1:1 to 1:10 or from 1:1 to 1:9 or from 1:1 to 1:8. In one embodiment, the fibre to liquid ratio is from 1:5 to 1:9 or from 1:6 to 1:8, e.g. about 1:7.

This optional removal of liquid carrier may be carried out in the method of making the precursor and/or may be carried out in the method of making the fibre-based composite material.

### The Substrate:

The substrate used in the present invention is suitably planar, or substantially planar.

The substrate may be made of any suitable material, such as a plastic or metal or alloy, for example it may be made from steel or aluminium or a similar material. It is preferred that the substrate is formed of a material such that it is inert to the constituents of the liquid carrier, binder and fibres.

The substrate may suitably be perforated and may have a first surface and an opposing second surface. In a particularly preferred embodiment, the substrate is in the form of a perforated screen having a first surface and an opposing second surface.

The substrate may have a number of perforations, such as five or more, ten or more, or twenty or more perforations. The perforations may, in one embodiment, have a maximum diameter less than the length of the shortest fibres in the starting material.

The substrate may be provided with a profile or rim defining an area in which the fibres are deposited. The profile or rim can act to funnel the liquid carrier through the perforations.

The profile may be formed with a number of flow points. The flow points may include entry points for entry of the starting material into the area in which the fibres are to be deposited. Alternatively or additionally the flow points may be one or more drainage points.

Increasing a density of drainage points in a part of the substrate may increase the drainage flow in that area and draw more fibre to that part, thereby increasing a density of deposited fibre in that part.

In one embodiment the substrate is in the form of a mesh. Alternatively, the substrate may be a perforated screen.

The substrate may be stationary, or the substrate may be arranged to move, such as by use of a conveyor belt.

The substrate may be provided within a mould or former. The substrate may, in one embodiment, be provided within a mould having side walls.

Step c-i): Curing the Binder:

In step c-i) the binder is cured. This acts to fix the 3D fibre matrix in a given shape. In one embodiment a shaped article is formed, e.g. a panel, which may have a rectangular or square cross section, or a three-dimensional moulded component (e.g. a battery housing or a fire door).

The curing step involves the application of heat. In particular, the fibrous matrix may be heated to a temperature greater than the melting temperature or greater than the curing temperature of the binder. In one embodiment, step c-i) involves heating the 3D fibre matrix to 70° C. or higher.

Any suitable technique for applying heat may be contemplated. For example, the heat may be supplied in the form of a hot air supply passing over the substrate or the heating may be achieved by electrical elements in the vicinity of the substrate. The fibrous matrix may be placed in an oven or may pass through an oven heated to a suitable temperature.

Preferably the curing step c-i) operates at a temperature from 70° C. to 450° C. In one preferred embodiment the temperature may be from 100° C. to 400° C. A particularly preferred range may be from 120° C. to 250° C. The curing temperature used may be dependent on the binder used and the thermal stability of the polymer binder. The temperature used in step c-i) should be lower than the degradation temperature of the binder.

In one embodiment the temperature used in step c-i) is in the range from 150° C. to 250° C., such as from 165° C. to 240° C. or from 175° C. to 230° C.

A typical cure for a 100% silicone resin system is 30 minutes at about 230° C. or 60 minutes at about 200° C.

The curing in step c-i) may have a duration of from a few seconds to several minutes.

Preferably the curing is from 10 seconds to 60 minutes, such as from 30 seconds to 45 minutes. In one embodiment the duration of the curing may be from 1 minute to 30 minutes.

In step c-i) the 3D fibre matrix is compressed, preferably while the matrix contains moisture. Thus, in step c-i) the binder is cured while pressure is applied. In one embodiment, a pressure is initially applied and then the binder is cured while the pressure continues to be applied.

A compression pressure of from 100 kPa to 50,000 kPa, such as from 100 kPa to 40,000 kPa or from 150 kPa to 35,000 kPa or from 250 kPa to 30,000 kPa or from 300 kPa to 25,000 kPa, is applied; this acts to reduce the thickness and volume of the fibrous matrix. In one embodiment, a compression pressure of from 400 kPa to 50,000 kPa, such as from 450 kPa to 40,000 kPa or from 500 kPa to 35,000 kPa or from 550 kPa to 30,000 kPa or from 600 kPa to 25,000 kPa, is applied.

The compression force may be applied by means of a static press. Alternatively, the compression force can be applied by means of a continuously fed nip roller or belt.

A preferred pressure may depend on the final volume fraction of fibre required. At low volume fractions of around 5-10% pressure of at least 40N/cm² (400 kPa) may usefully be applied. For higher volume fractions of 30%-40% a press pressure of 500N/cm² (5,000 kPa) or higher may be applied, for example the pressure may be up to 25,000 kPa, or even higher.

It has been found useful, in some embodiments, to apply pressure in two stages. A first stage may, for example, reduce the matrix to approximately 50% thickness compared to the original thickness (such as from 40 to 60% thickness compared to the original thickness). For example, a pressure of from 100 psi (670 kPa) to 300 psi (2,070 kPa), such as from 200 psi (1,380 kPa) to 300 psi (2,070 kPa), e.g. about 250 psi (1,725 kPa), may be used in the first stage. Preferably a higher pressure is used in a second stage to achieve increased fibre volume fraction. The pressures used in this second stage may, for example, be from 1000 psi (6,890 kPa) to 4000 psi (27,600 kPa) psi, such as from 1500 psi (10,300 kPa) to 3000 psi (20,700 kPa). It has been found that a secondary pressure of 1500 psi (10,300 kPa) may produce a fibre volume fraction in the region of 20-25% and a secondary pressure of 3000 psi (20,700 kPa) may increase the fibre volume fraction to 30-33%.

It has been found that compressing the fibrous matrix whilst it contains moisture (e.g. when the fibre to liquid ratio is in the range of from 1:1 to 1:25 or from 1:2 to 1:20, especially from 1:2 to 1:14) and curing the binder at substantially the same time has an advantageous effect. It has been found that after this treatment the undesired friable properties of the carbon fibres that are normally associated with high pressure treatment are, surprisingly, not evident or excessive. Fibre breakage does not occur. It has been found that a significant proportion of the main body fibre lengths are not fractured, powdered or reduced by the application of a compression force.

Therefore, in a preferred embodiment, the pressure is applied to the fibrous matrix while the matrix contains moisture with a fibre to liquid weight ratio of from 1:1 to 1:25 or from 1:2 to 1:20, especially from 1:2 to 1:14, such as from 1:2 to 1:10.

Once the binder has cured, the fibre matrix will not be able to relax and spring back to a greater thickness (with a resulting reduction in fibre to volume fraction). Therefore, there is no need to continue to apply pressure once the curing step c-i) has been completed.

Heat may continue to be applied to the fibre matrix once curing has been completed in order to fully dry the matrix. The temperature may be increased to a temperature at which curing takes place and maintained at that temperature until the matrix is cured and the temperature may then be adjusted to a temperature at which drying of the matrix occurs. The matrix may be dried at a temperature that is from 100° C. to 450° C. In a preferred embodiment the drying temperature may be from 100° C. to 400° C., e.g. from 250° C. to 400° C.

Heating of the matrix may be by means of a plate, such as a heavy metal plate. A plate may be provided on one side only of the matrix but is preferably provided on both sides of the matrix. In one embodiment the temperature of the matrix is increased continuously to the curing temperature. In one preferred embodiment the temperature is raised to 100° C. to 120° C. and held at this temperature for a period of time to allow steam to escape from the matrix. The period of time may be from a few minutes to a few hours. More particularly the time may vary from 5 minutes to 2 hours. The time may be dependent on a thickness of the matrix. In a preferred embodiment in which the thickness is 6 mm the heating time at 100° C. to 120° C. is 6 minutes; for an embodiment in which the thickness is 35 mm the heating time at 100° C. to 120° C. is 1 hour.

In one embodiment the fibrous matrix is further cooled under compression following the curing step c-i). However, this is not essential, and the matrix may be cooled under atmospheric pressure.

Step b), and step c-i), plus any optional cooling steps, may be a continuous process or may be a batch process.

### Shaped Article:

The shaped article that may be obtained according to the invention may be a panel or may be a 3D moulded component.

The panel may have a thickness of 1 mm or more, or 2 mm or more, or 5 mm or more, such as 10 mm or more or 15 mm or more. Thicknesses below 5 mm will generally find application in a laminate structure, where there are further layers of structural material, whilst thicknesses of 5 mm or more may be used alone as a structural material or may be used in a laminate structure.

The panel may have a thickness of from 1 mm to 150 mm or from 1 mm to 100 mm or from 1 mm to 50 mm. In one embodiment the thickness may be from 1 mm to 40 mm, or from 1 mm to 30 mm, such as from 1 mm to 20 mm.

It may be that the panel has a thickness of from 2 mm to 150 mm or from 2 mm to 100 mm or from 2 mm to 50 mm. In one embodiment the thickness may be from 2 mm to 40 mm, or from 2 mm to 30 mm, such as from 2 mm to 20 mm.

It may be that the panel has a thickness of 5 mm to 150 mm or from 5 mm to 100 mm or from 5 mm to 50 mm. In one embodiment the thickness may be from 5 mm to 40 mm, or from 5 mm to 30 mm, such as from 5 mm to 20 mm.

The panel may have any desired width and length. It may be provided as a panel that can be cut to a desired size or it may be provided as a modular panel whereby two or more such panels can be used in combination. In one embodiment, the width is 25 cm or more, or 50 cm or more, or 75 cm or more, such as from 25 cm to 5 m or from 25 cm to 2.5 m. In one embodiment, the length is 25 cm or more, or 50 cm or more, or 75 cm or more, such as from 25 cm to 5 m or from 25 cm to 2.5 m.

The 3D moulded component may be any size and shape. The skilled person will appreciate that a mould of any desired size and shape can be provided and that this can be larger in size than the substrate. In one embodiment the 3D moulded component may have a size up to 2.5 square metres, or even more. In one embodiment the 3D moulded component is a housing or enclosure for a battery, or a door, wall, floor panel, ceiling panel, deck, platform or cladding. In one embodiment the 3D moulded component is a component for use in mass transit.

### Precursor:

In the present invention a precursor can be obtained by carrying out steps a) and b) and then instead of curing the binder, heating the matrix to a temperature that softens or melts the binder around the fibres, but does not cure the binder. This will result in a precursor product that is a flexible fibrous mat.

The heating step c-ii) involves a temperature of 40° C. or more. In step c-ii) the temperature of heating and the duration of the heating are chosen such that the binder does not cure.

The skilled person will appreciate that this may involve a lower temperature for a longer period of time, or a higher temperature for a shorter period of time. For example, the temperature may be from 40° C. to 100° C., such as from 40° C. to 80° C. or from 40° C. to 60° C., for a period of time of from 3 to 15 minutes, such as from 5 to 15 minutes. Alternatively, the temperature may be from 100° C. to 250° C., such as from 125° C. to 225° C. or from 150° C. to 200° C., for a period of time of 1 minute or less, such as from 15 seconds to 45 seconds.

The thicker the mat, the higher the heating temperature and/or longer the heating time needs to be, in order to ensure that all of the binder is heated and softens.

It may be desirable to carry out a dewatering step, as described above, before heating in step c-ii).

Once the precursor product has been obtained, it can be stored or transported. The precursor product can then be converted to the composite material or shaped article when needed.

The conversion to the composite material or shaped article involves curing the binder by the application of heat and pressure. The same temperatures and pressures as described for step c-i) of the method of the first aspect will be appropriate.

The invention will now be further described, in a non-limiting manner, by reference to the following examples:

### Example 1

A fibre-based composite material was formed using a chopped blend of virgin carbon fibre with different lengths selected from 6 mm, 12 mm, 18 mm, 24 mm, 30 mm, 36 mm, 42 mm and 48 mm and in the following amounts:
6-18 mm length fibres=28 wt %
24-36 mm length fibres=53 wt %
42-48 mm length fibres=19 wt %

The chopped carbon fibre was combined with silicone binder and water to provide the starting material.

The starting material was 0.07 wt % chopped carbon fibre, 0.07 wt. % silicone binder and 99.86 wt % water.

The starting material was passed to a mesh substrate, located within a mould, via a manifold having a single entry and eight pipe outlets. The starting material drops into the manifold via its single entry and drains from the eight manifold outlets into the mould. The manifold is positioned above the mesh substrate so that the slurry drops from a height of about 2.1 m onto the mesh substrate.

The starting material passed over the mesh substrate, depositing fibres and binder onto the substrate, and was subjected to a vacuum force of approximately 700 torr.

The resulting matrix of fibres and binder was then heated to a temperature of 190° C. under a compression force of 260N/cm².

The resulting fibre-based composite material was pressed to a thickness of 2 mm and a panel of dimensions 130 cm×80 cm×2 mm was obtained for testing.

### Example 2

A fibre-based composite material was obtained and pressed into panel form using the same approach as Example 1 except that the chopped carbon fibre blend was:
6-18 mm length fibres=26 wt %
24-36 mm length fibres=49 wt %
42-48 mm length fibres=25 wt % The starting material was 0.02 wt % chopped carbon fibre, 0.02 wt. % silicone binder and 99.96 wt % water.

### Example 3

A fibre-based composite material was obtained and pressed into panel form using the same approach as Example 1 except that the chopped carbon fibre blend was:
6-18 mm length fibres=28 wt %
24-36 mm length fibres=51 wt %
42-48 mm length fibres=21 wt % The starting material was 0.035 wt % chopped carbon fibre, 0.045 wt. % silicone binder and 99.92 wt % water.

### Comparative Example 1

A fibre-based composite material was obtained and pressed into panel form using the same approach as Example 1 except that the chopped carbon fibre was provided in a single length of 12 mm.

### Comparative Example 2

A fibre-based composite material was obtained and pressed into panel form using the same approach as Example 1 except that the chopped carbon fibre was provided in a single length of 48 mm.

### Comparative Example 3

A fibre-based composite material was obtained and pressed into panel form using the same approach as Example 1 except that the chopped carbon fibre blend was:
6 mm length fibres=50 wt %
12 mm length fibres=25 wt %
24 mm length fibres=25 wt %
   and the binder used was polyamide PA66.

### Test Protocol

Two test areas were sampled from each panel, both sized 31.5 cm×26.5 cm. The front surface of each test area was subjected to a 1200° C. flame from a blow torch (a propylene and propane gas fueled Rothenberger Superfire 2 torch with MAPP 400 g gas cartridge) for an hour. A visual assessment of damage and any burn-through was carried out. A thermocouple (Type K thermocouple 150 mm length 3 mm diameter) and a temperature data logger (Pico Technology USB TC-08 8 channel temperature data logger) were used to monitor the temperature at the surface.

### Results

| Test sample | Results |
|---|---|
| Example 1 | The panel withstood the flame for the 1-hour test |
| | period. The front surface showed discoloration but no |
| | significant loss of material or damage. |
| Example 2 | The panel withstood the flame for the 1-hour test |
| | period. The front surface showed discoloration but no |
| | significant loss of material or damage. |
| Example 3 | The panel withstood the flame for the 1-hour test |
| | period. The front surface showed discoloration but no |
| | significant loss of material or damage. |
| Comparative | The panel showed significant damage and by 1-hour |
| Example 1 | the flame had burnt through the panel thickness |
| | completely. |
| Comparative | The panel showed significant damage and by 1-hour |
| Example 2 | the flame had burnt through the panel thickness |
| | completely. |
| Comparative | The panel was not burnt through its thickness but |
| Example 3 | binder was burnt away leaving an expanded area of |
| | weak loose fibres with visible damage. |

### Further Testing

The test on the fibre-based composite material of Example 1 was continued such that the surface was exposed to the flame for a total of 7 hours.

Even after being subjected to the blow torch flame for 7 hours, there was no burn through, and the panel remained intact.

### Summary of Testing

In all the testing carried out, products made from a starting material which comprised liquid carrier, fibres and binder, wherein the binder comprises silicone resin and wherein the fibres are chopped carbon fibres which comprise a mixture of three or more different lengths of fibre each within the range of from 6 mm to 48 mm, and wherein the fibres comprise from 10 to 50 wt % fibres within the length range of from 6 mm to 18 mm, from 30 to 70 wt % fibres within the length range of from 19 mm to 36 mm, and from 5 to 35 wt % fibres within the length range of from 37 mm to 48 mm, gave excellent results in terms of resistance to high temperature and flame resistance.

Products did not exhibit the desired temperature and flame resistance when they were made from a starting material where:
the binder did not comprise the required silicone resin; or
the chopped carbon fibres did not comprise the required mixture of three or more different lengths of fibre within the range of from 6 mm to 48 mm.

As compared to WO2011/007184, the present invention teaches the required novel combination of technical features in terms of chopped carbon fibres lengths and binder that allow high temperature resistance (such as 1000° C. or higher) to be achieved, together with flame resistance.

1. A method of making a fibre-based composite material, the method comprising:
a) providing a starting material which comprises liquid carrier, fibres and binder, wherein the binder comprises silicone resin and wherein the fibres are chopped carbon fibres which comprise a mixture of three or more different lengths of fibre each within the range of from 6 mm to 48 mm, wherein a first length is within the range of from 6 mm to 18 mm, wherein a second length is within the range of from 19 mm to 36 mm and wherein a third length is within the range of from 37 mm to 48 mm;
b) dropping the starting material from a height onto a substrate, via a plurality of outlet points, so as to deposit the fibres and the binder onto the substrate in the form of a three-dimensional fibre matrix; and
c-i) curing the binder by applying heat whilst applying a pressure of from 100 kPa to 50,000 kPa, to thereby obtain the fibre-based composite material.

2. A fibre-based composite material comprising a non-woven substrate of fibres in a form of a stochastic three-dimensional matrix, wherein the matrix has the fibres arranged in x, y and z directions, and the fibres are randomly oriented, wherein the fibres are held together in the matrix formation by a cured binder, wherein the cured binder comprises silicone resin and wherein the fibres are chopped carbon fibres which comprise a mixture of three or more different lengths of the fibre each within the range of from 6 mm to 48 mm, wherein a first length is within the range of from 6 mm to 18 mm, wherein a second length is within the range of from 19 mm to 36 mm and wherein a third length is within the range of from 37 mm to 48 mm.

3. The fibre-based composite material of claim 2, wherein the fibre-based composite material is in a form of a shaped article.

4. The fibre-based composite material of claim 3, wherein the shaped article is a 3D moulded component or panel for use in a vehicle, a train, aeroplane, ferry, coach, bus, tram, ship or car.

5. (canceled)

6. (canceled)

7. (canceled)

8. (canceled)

9. (canceled)

10. (canceled)

11. (canceled)

12. The fibre-based composite material of claim 2, wherein the fibres comprise from 10 to 50 wt % fibres within the length range of from 6 mm to 18 mm, from 30 to 70 wt % fibres within the length range of from 19 mm to 36 mm, and from 5 to 35 wt % fibres within the length range of from 37 mm to 48 mm.

13. The fibre-based composite material of claim 2, wherein the fibres comprise from 15 to 50 wt % fibres within the range of from 6 mm to 18 mm, from 35 to 70 wt % fibres within the range of from 19 mm to 36 mm and from 10 to 35 wt % fibres within the range of from 37 mm to 48 mm.

14. The fibre-based composite material of claim 2, wherein the fibres comprise from 15 to 45 wt % fibres within the range of from 6 mm to 18 mm, from 35 to 65 wt % fibres within the range of from 19 mm to 36 mm and from 10 to 30 wt % fibres within the range of from 37 mm to 48 mm.

15. The fibre-based composite material of claim 2, wherein the fibres comprise from 20 to 45 wt % fibres within the range of from 6 mm to 18 mm, from 40 to 65 wt % fibres within the range of from 19 mm to 36 mm and from 15 to 30 wt % fibres within the range of from 37 mm to 48 mm.

16. The fibre-based composite material of claim 2, wherein the fibres comprise from 20 to 40 wt % fibres within the range of from 6 mm to 18 mm, from 40 to 60 wt % fibres within the range of from 19 mm to 36 mm and from 15 to 25 wt % fibres within the range of from 37 mm to 48 mm.

17. The fibre-based composite material of claim 2, wherein the fibres comprise fibre lengths selected from 6 mm, 12 mm, 18 mm, 24 mm, 30 mm, 36 mm, 42 mm and 48 mm, wherein there being three or more, or four or more, or five or more, different length fibres.

18. The fibre-based composite material of claim 2, wherein the fibres comprise chopped carbon fibres where there are three or more different lengths present within the range of from 12 mm to 48 mm, and wherein the three or more different lengths being selected from 12 mm, 18 mm, 24 mm, 30 mm, 36 mm, 42 mm and 48 mm.

19. (canceled)

20. The fibre-based composite material of claim 2, wherein the silicone resin is a methyl-substituent based silicone resin, a phenyl-substituent based silicone resin, or a silicone resin with both methyl and phenyl substituents.

21. The fibre-based composite material of claim 2, wherein the silicone resin includes silanol and/or methoxy functionality.

22. The fibre-based composite material of claim 2, wherein the silicone resin has a weight average molecular weight in the range of 500 to 10,000.

23. (canceled)

24. The fibre-based composite material of claim 2, wherein a percentage of binder is from 30% to 80% of a final weight of the fibre-based composite material.

25. The method of making the fibre-based composite material of claim 1, wherein the fibres comprise from 10 to 50 wt % fibres within the length range of from 6 mm to 18 mm, from 30 to 70 wt % fibres within the length range of from 19 mm to 36 mm, and from 5 to 35 wt % fibres within the length range of from 37 mm to 48 mm.

26. The method of making the fibre-based composite material of claim 1, wherein the fibres comprise from 15 to 50 wt % fibres within the range of from 6 mm to 18 mm, from 35 to 70 wt % fibres within the range of from 19 mm to 36 mm and from 10 to 35 wt % fibres within the range of from 37 mm to 48 mm.

27. The method of making the fibre-based composite material of claim 1, wherein the fibres comprise from 15 to 45 wt % fibres within the range of from 6 mm to 18 mm, from 35 to 65 wt % fibres within the range of from 19 mm to 36 mm and from 10 to 30 wt % fibres within the range of from 37 mm to 48 mm.

28. The method of making the fibre-based composite material of claim 1, wherein the fibres comprise from 20 to 45 wt % fibres within the range of from 6 mm to 18 mm, from 40 to 65 wt % fibres within the range of from 19 mm to 36 mm and from 15 to 30 wt % fibres within the range of from 37 mm to 48 mm.

29. The method of making the fibre-based composite material of claim 1, wherein the fibres comprise from 20 to 40 wt % fibres within the range of from 6 mm to 18 mm, from 40 to 60 wt % fibres within the range of from 19 mm to 36 mm and from 15 to 25 wt % fibres within the range of from 37 mm to 48 mm.
